(19) United States
(12) Patent Application Publication
(10) Pub. No.: US 2016/0034814 A1
(43) Pub. Date: Feb. 4, 2016

(54) NOISE-BOOSTED BACK PROPAGATION AND DEEP LEARNING NEURAL NETWORKS

(71) Applicants: Kartik Audhkhasi, White Plains, NY (US); Osonde Osoba, Los Angeles, CA (US); Bart Kosko, Hacienda Heights, CA (US)

(72) Inventors: Kartik Audhkhasi, White Plains, NY (US); Osonde Osoba, Los Angeles, CA (US); Bart Kosko, Hacienda Heights, CA (US)

(73) Assignee: UNIVERSITY OF SOUTHERN CALIFORNIA, Los Angeles, CA (US)

(21) Appl. No.: 14/816,999

(22) Filed: Aug. 3, 2015

Related U.S. Application Data
(60) Provisional application No. 62/032,451, filed on Aug. 1, 2014.

(51) Int. Cl. G06N 3/08; G06N 99/00; G06N 3/04

(52) U.S. Cl. CPC G06N 3/08; G06N 3/0436; G06N 99/005

(57) ABSTRACT

A learning computer system may update parameters and states of an uncertain system. The system may receive data from a user or other source; process the received data through layers of processing units, thereby generating processed data; process the processed data to produce one or more intermediate or output signals; compare the one or more intermediate or output signals with one or more reference signals to generate information indicative of a performance measure of one or more of the layers of processing units; send information indicative of the performance measure back through the layers of processing units; process the information indicative of the performance measure in the processing units and in interconnections between the processing units; generate random, chaotic, fuzzy, or other numerical perturbations of the received data, the processed data, or the one or more intermediate or output signals; update the parameters and states of the uncertain system using the received data, the numerical perturbations, and previous parameters and states of the uncertain system; determine whether the generated numerical perturbations satisfy a condition; and if the numerical perturbations satisfy the condition, inject the numerical perturbations into one or more of the parameters or states, the received data, the processed data, or one or more of the processing units.

### CROSS-REFERENCE TO RELATED APPLICATIONS

This application is based upon and claims priority to U.S. provisional patent application 62/032,451, entitled “Noise-Boosted Back Propagation and Deep Learning Neural Networks Title,” filed Aug. 1, 2014, attorney docket number 094852-0030.

This application is also related to U.S. patent application Ser. No. 14/802,760, entitled “Noise Speed-Ups in Hidden Markov Models with Applications to Speech Recognition,” filed Jul. 17, 2015, attorney docket number 094852-0110 and Ser. No. 14/803,797, entitled “Noise-Enhanced Convolutional Neural Networks,” filed Jul. 20, 2015, attorney docket number 094852-0109.

The entire content of each of these applications and patents is incorporated herein by reference.

### BACKGROUND

1. Technical Field

This disclosure relates to learning computer systems that update parameters and states of an uncertain system.

2. Description of Related Art

Backpropagation (BP) is a popular method for training neural networks. The goal of BP is to tune a neural network (NN) architecture so that it approximates the arbitrary function mapping inputs to outputs in a training set. BP works by projecting one of the training input patterns forward through the NN and comparing the resulting output to the desired output to generate an error signal.

One typical error signal is the squared difference between the actual and desired outputs. Another error signal is the cross-entropy between the actual and desired output. The BP procedure uses the error signal to tune the network parameters via gradient descent. Tuning involves the repeated application of the chain rule on the error signal to estimate the sensitivity and optimal changes to network parameter to reduce the error. The process repeats over other input-output pairs in the training data set. FIG. 1 illustrates one iteration of the BP training procedure.

The backpropagation (BP) algorithm [D. Rumelhart, G. Hinton, and R. Williams, “Learning representations by back-propagating errors,” Nature, pp. 323-533, 1986; B. Kosko, Neural networks and fuzzy systems: A dynamical systems approach to machine intelligence. Prentice Hall, 1991; S. Haykin, Neural networks: A comprehensive foundation. Prentice Hall, 1998.] may be recast as a special case of the generalized Expectation-Maximization (EM) algorithm. EM is a general method for maximum likelihood estimation given missing data or parameters [A. P. Dempster, N. M. Laird, and D. B. Rubin, “Maximum likelihood from incomplete data via the EM algorithm,” Journal of the Royal Statistical Society. Series B (Methodological), pp. 1-38, 1977; G. J. McLachlan and T. Krishnan, The EM algorithm and extensions. Wiley-Interscience, 2007, vol. 382].

Training neural networks with BP remains a popular approach to many difficult and large scale problems of pattern recognition and signal processing. BP scales well because its time complexity is only O(n) for n training samples. Its forward pass is O(1) while its backward error pass has O(n) complexity. Support vector machines and other kernel methods have O(n²) complexity [S. Y. Kung, Kernel methods and machine learning. Cambridge University Press, 2014]. Key neural applications include speech recognition [A. Mohamed, G. Dahl, and G. Hinton, “Deep belief networks for phone recognition,” in Proc. NIPS Workshop on Deep Learning for Speech Recognition and Related Applications, 2009; A. Mohamed, D. Yu, and L. Deng, “Investigation of full-sequence training of deep belief networks for speech recognition,” in Proc. Interspeech. Citeseer, 2010, pp. 2846-2849; A. Mohamed, G. Dahl, and G. Hinton, “Acoustic modeling using deep belief networks,” IEEE Transactions on Audio, Speech, and Language Processing, vol. 20, no. 1, pp. 14-22, 2012; F. Seide, G. Li, and D. Yu, “Conversational speech transcription using context-dependent deep neural networks,” in Proc. Interspeech, 2011, pp. 437-440; G. Dahl, M. Ranzato, A. Mohamed, and G. Hinton, “Phone recognition with the mean-covariance restricted boltzmann machine,” Proc. NIPS, vol. 23, pp. 469-477, 2010; T. Sainath, B. Kingsbury, B. Ramabhadran, P. Fousek, P. Novak, and A. Mohamed, “Making deep belief networks effective for large vocabulary continuous speech recognition,” in Proc. ASRU. IEEE, 2011, pp. 30-35; A. Mohamed, T. Sainath, G. Dahl, B. Ramabhadran, G. Hinton, and M. Picheny, “Deep belief networks using discriminative features for phone recognition,” in Acoustics, Speech and Signal Processing (ICASSP), 2011 IEEE International Conference on. IEEE, 2011, pp. 5060-5063], machine translation of text [T. Deselaers, S. Hasan, O. Bender, and H. Ney, “A deep learning approach to machine transliteration,” Proceedings of the Fourth Workshop on Statistical Machine Translation, 2009, pages 233-241, audio processing [P. Hamel and D. Eck, “Learning features from music audio with deep belief networks,” in Proc. ISMIR, 2010], artificial intelligence [Y. Bengio, “Learning deep architectures for Al,” Foundations and Trends in Machine Learning, vol. 2, no. 1, pp. 1-127, 2009], computer vision [D. Ciresan, U. Meier, L. Gambardella, and J. Schmidhuber, “Deep, big, simple neural nets for handwritten digit recognition,” Neural computation, vol. 22, no. 12, pp. 3207-3220, 2010; V. Nair and G. Hinton, “3d object recognition with deep belief nets,” Advances in Neural Information Processing Systems, vol. 22, pp. 1339-1347, 2009; J. Susskind, G. Hinton, J. Movellan, and A. Anderson, “Generating facial expressions with deep belief nets,” Affective Computing, Emotion Modelling, Synthesis and Recognition, pp. 421-440, 2008], medicine [X. Hu, H. Cammann, H.-A. Meyer, K. Miller, K. Jung, and C. Stephan, “Artificial neural networks and prostate cancer tools for diagnosis and management,” Nature Reviews Urology, 2013], and general multilayered or deep learning [Y. LeCun, Y. Bengio, and G. Hinton, “Deep learning,” Nature, vol. 521, pp. 436-444, 2015, M. Jordan and T. Mitchell, “Machine learning: trends, perspectives, and prospects,” Science, vol. 349].

BP remains the workhorse of deep learning [Y. LeCun, Y. Bengio, and G. Hinton, “Deep learning,” Nature, vol. 521, pp. 436-444, 2015, M. Jordan and T. Mitchell, “Machine learning: trends, perspectives, and prospects,” Science, vol. 349]. Deep learning with neural networks trains deep stacked layers of neurons pattern recognition and signal processing. The training performance of such deep networks can be sensitive to initial network parameters. The training procedure may benefit from pretraining methods that seek favorable initial network parameters. One approach to pre-training modifies connection weights between adjacent layers by tuning the two layers as a Restricted Boltzmann Machine.

Restricted Boltzmann Machines [M. Jordan and T. Mitchell, “Machine learning: trends, perspectives, and prospects,” Science, vol. 349; C. M. Bishop, Pattern recognition and machine learning. springer, 2006] are a special type of bidirectional associative memory (BAM) [D. Rumelhart, G. Hinton, and R. Williams, “Learning representations by back-propagating errors,” Nature, pp. 323-533, 1986; O. Osoba, S. Mitaim, and B. Kosko, “The noisy expectation—maximization algorithm,” Fluctuation and Noise Letters, vol. 12, no. 03, p. 1350012, 2013; O. Osoba and B. Kosko, “Noise-Enhanced Clustering and Competitive Learning Algorithms,” Neural Networks, January 2013]. Bidirectional associative memories (BAMs) refer to groups of neurons connected in a bipartite layout via a synaptic connection (network edge weight) matrix W on the forward pass and the transpose matrix W^{T} on the backward pass. They encode patterns for hetero-associative recall. RBMs are neurons in a bipartite layout with a connection matrix W and an associated energy function on the neuron activations. RBMs are in fact bidirectional associative memories (BAMs) [D. Rumelhart, G. Hinton, and R. Williams, “Learning representations by back-propagating errors,” Nature, pp. 323-533, 1986; O. Osoba, S. Mitaim, and B. Kosko, “The noisy expectation—maximization algorithm,” Fluctuation and Noise Letters, vol. 12, no. 03, p. 1350012, 2013; O. Osoba and B. Kosko, “Noise-Enhanced Clustering and Competitive Learning Algorithms,” Neural Networks, January 2013] that undergo synchronous updating of the neurons. RBM tuning often serves as a pre-training or layer initialization for deep stacks of feedforward NNs. The lower level is visible during training of deep neural networks while the higher layer is hidden. BAMs (and RBMs) enjoy rapid convergence to a bidirectional fixed point for synchronous updating of the neurons. The general BAM Theorem ensures that such BAM or RBM connection matrices W are bidirectionally stable for threshold neurons as well for most continuous neurons. Logistic neurons satisfy the BAM Theorem because logistic signal functions are bounded and monotone decreasing.

### SUMMARY

A learning computer system may update parameters and states of an uncertain system. The system may include a data processing system that may include a hardware processor. The system may receive data from a user or other source; process the received data through layers of processing units, thereby generating processed data; process the processed data to produce one or more intermediate or output signals; compare the one or more intermediate or output signals with one or more reference signals to generate information indicative of a performance measure of one or more of the layers of processing units; send information indicative of the performance measure back through the layers of processing units; process the information indicative of the performance measure in the processing units and in interconnections between the processing units; generate random, chaotic, fuzzy, or other numerical perturbations of the received data, the processed data, or the one or more intermediate or output signals; update the parameters and states of the uncertain system using the received data, the numerical perturbations, and previous parameters and states of the uncertain system; determine whether the generated numerical perturbations satisfy a condition; and if the numerical perturbations satisfy the condition, inject the numerical perturbations into one or more of the parameters or states, the received data, the processed data, or one or more of the processing units.

The learning computer system may unconditionally inject noise or chaotic or other perturbations into one or more of the estimated parameters or states, the received data, the processed data, or one or more of the processing units.

The unconditional injection may speed up learning by the learning computer system and/or improve the accuracy of the learning computer system.

If the numerical perturbations do not satisfy the condition, the system may not inject the numerical perturbations into one or more of the parameters or states, the received data, the processed data, or one or more of the processing units.

The received data may represent an image, a speech signal, or other signal.

A learning computer system may receive data from a user or other source; process the received data bi-directionally through two layers of processing units, thereby generating processed data; generate random, chaotic, fuzzy, or other numerical perturbations of the received data, the processed data, or one or more signals within the two layers of processing units; update the parameters and states of the uncertain system using the received data, the numerical perturbations, and previous parameters and states of the uncertain system; determine whether the generated numerical perturbations satisfy a condition; and if the numerical perturbations satisfy the condition, inject the numerical perturbations into one or more of the parameters or states, the received data, the processed data, or one or more of the processing units.

The learning computer system may repeat all of the steps of the last paragraph, except that the processing step during the repeat processes one or both of the two layers of processing units along with a third layer of a processing unit.

The learning computer system may repeat all of the steps of the last paragraph until the received data has been processed bi-directionally through all of the layers of the processing units.

The processing units in the two layers of processing units may process bi-polar signals.

A non-transitory, tangible, computer-readable storage medium containing a program of instructions may cause a learning computer system running the program of instructions that has a data processing system that includes a hardware processor to perform one or more of the steps described herein.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates that back-propagation (BP) is a special case of the Expectation-Maximization (EM) algorithm. The forward pass of input data through the neural network is equivalent to the Expectation (E) step and the back-propagation of the gradients is equivalent to the Maximization (M) step. Theorem 1 proves this equivalence between BP and EM.

FIG. 2A illustrates NEM-BP noise benefit in training set cross-entropy over first 10 iterations using a 5-layer neural network with 40 neurons in each hidden layer. These figures show the percent median reduction in per-iteration cross entropy for the NEM-backpropagation (NEM-BP) training relative to the noiseless EM-BP training of a 10-class classification neural network trained on 1000 images from the MNIST data set. A reduction in cross entropy of 18% is observed for the training and the testing set at the optimal noise standard deviation of 0.42. The neural network used three logistic (sigmoidal) hidden layers with 40 neurons each. The input layer used 784 logistic neurons and the output layer used 10 neurons with Gibbs activation function. FIG. 2B illustrates the training set cross entropy as iterations proceed for EM-BP and NEM-BP training using the optimal noise variance of 0.42. The kneepoint of the NEM-BP curve at iteration 4 achieves the same cross entropy as does the noiseless EM-BP at iteration 15.

FIG. 3A illustrates blind-BP noise benefit in training set cross-entropy over the first 10 iterations using a 5-layer neural network with 40 neurons in each hidden layer. This figure shows the percent median reduction in per-iteration cross entropy for the EM-backpropagation training with blind noise (BlindBP) relative to the noiseless EM-BP training of a 10-class classification neural network trained on 1000 images from the MNIST data set. We observe a marginal reduction in cross entropy of 1.7% for the training and the testing set at the optimal noise standard deviation of 0.54. The neural network used three logistic (sigmoidal) hidden layers with 40 neurons each. The input layer used 784 logistic neurons and the output layer used 10 neurons with Gibbs activation function. FIG. 3B illustrates the training set cross entropy as iterations proceed for EM-BP and Blind-BP training using the optimal noise variance of 0.54. Both the blind noise EM-BP and the noise less EM-BP give similar cross-entropies for all iterations.

FIG. 4A illustrates NEM-BP noise benefit in training set classification error over first 10 iterations using a 5-layer neural network with 40 neurons in each hidden layer. This figure shows the percent median reduction in per-iteration classification error rate for the NEM-backpropagation (NEM-BP) training relative to the noiseless EM-BP training of a 10-class classification neural network trained on 1000 images from the MNIST data set. A reduction in classification error rate of 15% was observed for the training and around 10% for the testing set at the optimal noise standard deviation of 0.42. The neural network used three logistic (sigmoidal) hidden layers with 40 neurons each. The input layer used 784 logistic neurons and the output layer used 10 neurons with Gibbs activation function. FIG. 4B illustrates the training set classification error rate as iterations proceed for EM-BP and NEM-BP training using the optimal noise variance of 0.42. The knee-point of the NEMBP curve at iteration 4 achieves the same classification error rate as does the noiseless EM-BP at iteration 11.

FIG. 5A illustrates blind-BP noise benefit in training set classification error over first 10 iterations using a 5-layer neural network with 40 neurons in each hidden layer. FIG. 5B illustrates the training set classification error rate for an optimal noise variance of 2.8e-1.

FIG. 6A Illustrates the percent median reduction in per-iteration squared reconstruction error for the training with NEM noise relative to the noiseless training of a BAM on 1000 images from the MNIST data set. A reduction of 16% in the training set squared reconstruction error was observed at the optimal noise variance of 1024. The BAM used one logistic (sigmoidal) hidden layers with 40 neurons and an input layer with 784 logistic neurons. FIG. 6B illustrates the training set squared reconstruction error as iterations proceed for NEM and noiseless training using the optimal noise variance of 1024.

FIG. 7A illustrates the percent median reduction in per-iteration squared reconstruction error for the training with blind noise relative to the noiseless training of a BAM on 1000 images from the MNIST data set. No significant difference in the per-iteration squared reconstruction error for the two cases was observed. The BAM used one logistic (sigmoidal) hidden layers with 40 neurons and an input layer with 784 logistic neurons. FIG. 7B illustrates the training set squared reconstruction error for an optimal noise variance of 1.

FIG. 8 illustrates a noise benefit region for a neural network with Bernoulli (logistic) output neurons: Noise speeds up maximum-likelihood parameter estimation of the neural network with Bernoulli output neurons if the noise lies above a hyperplane that passes through the origin of the noise space. The activation signal at of the output layer controls the normal to the hyperplane. The hyperplane changes as learning proceeds because the parameters and hidden layer neuron activations change. Independent and identically distributed (i.i.d.) Gaussian noise was used with mean 0, variance 3, and (3,1,1) as the normal to the hyperplane.

FIG. 9 illustrates a noise benefit region for a neural network with Gaussian output neurons: Noise speeds up maximum-likelihood parameter estimation of the neural network with Gaussian output neurons if the noise lies inside a hypersphere. The activation signal at of the output layer and the target signal t control the center and radius of this hypersphere. This hypersphere changes as learning proceeds because the parameters and hidden-layer neuron activations change. Ii.i.d. Gaussian noise was used with mean 0, variance 3, and center at=(1; 1; 1).

FIG. 10A illustrates the effects of noise injection only in the hidden layers of an artificial neural network. The neural network uses 3 hidden layers with 40 neurons each to solve the MNIST digit recognition task. The network was trained with regular backpropagation and NEM-modified versions of backpropagation. The addition of noise subject to the NEM condition in the hidden layers gives a relative improvement in training cross-entropy by an average of 60.44% over the first 5 iterations. The relative misclassification rate also improves by an average of 54.39%. The additive noise has an initial power of 0.903 and with an annealing factor of 4. A grid search of the parameter space was done for good initial noise power and annealing factor parameters. FIG. 10B illustrate the test set for cross-entropy error.

FIG. 11 illustrates mean squared reconstruction error of logistic-logistic BAM with 784 input and 40 hidden neurons. This figure shows the mean squared reconstruction error using binary and bipolar coding of the input data during BAM encoding. Bipolar coding gives much faster convergence in terms of mean-squared reconstruction error of the BAM input when compared to binary coding. A logistic-logistic BAM was used with 784 input and 40 hidden neurons and trained it on 1000 digit images from the MNIST data set. Bipolar encoding of the input image pixels gives convergence in around 25 iterations while training with binary encoding converges in nearly 500 iterations.

FIG. 12 illustrates an example of a learning computer system that estimates unknown parameters and states of a stochastic or uncertain system.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

As will now be discussed in more detail, noise can speed convergence and improve accuracy of the popular backpropagation gradient-descent algorithm for training feedforward multilayer-perceptron neural networks. This is because the backpropagation (BP) algorithm may be recast as a special case of the generalized Expectation-Maximization (EM) algorithm [D. Rumelhart, G. Hinton, and R. Williams, “Learning representations by back-propagating errors,” Nature, pp. 323-533, 1986; B. Kosko, Neural networks and fuzzy systems: A dynamical systems approach to machine intelligence. Prentice Hall, 1991; S. Haykin, Neural networks: A comprehensive foundation. Prentice Hall, 1998]. This recasting of BP as EM is different from simply applying EM to BP or using BP in EM [G. D. Cook and A. J. Robinson, “Training MLPs via the expectation maximization algorithm,” in Proc. Artificial Neural Networks. IET, 1995; S.-K. Ng and G. J. McLachlan, “Using the EM algorithm to train neural networks: misconceptions and a new algorithm for multiclass classification,” IEEE Transactions on Neural Networks, vol. 15, no. 3, pp. 738-749, 2004]. Such efforts treated EM and BP as different algorithms. The link between the two algorithms is deeper. EM subsumes BP.

### Theorem 1: Backpropagation is the GEM Algorithm

The backpropagation update equation for a differentiable likelihood function p(y|x,θ) at epoch n

θⁿ⁺¹=θⁿ+η∇_{θ} log p(y|x,θ)|_{θ=θ}_{ⁿ} (1)

equals the GEM update equation at epoch n

θⁿ⁺¹=θⁿ+η∇_{θ}Q(θ|θⁿ)|_{θ=θ}_{ⁿ} (2)

where the GEM uses the differentiable Q-function

Q(θ|θⁿ)=E_{p(h|x,y,θ}_{ⁿ}₎{ log p(y,h|x,θ)}. (3)

Thus, the recent Noisy Expectation Maximization (NEM) results imply that the careful application of noise speeds convergence in the backpropagation algorithm. The application of the NEM result also provides speed benefits for pretraining.

The Noisy Expectation-Maximization (NEM) algorithm [A. P. Dempster, N. M. Laird, and D. B. Rubin, “Maximum likelihood from incomplete data via the EM algorithm,” Journal of the Royal Statistical Society. Series B (Methodological), pp. 1-38, 1977; G. J. McLachlan and T. Krishnan, The EM algorithm and extensions. Wiley-Interscience, 2007, vol. 382] modifies the EM scheme and achieves faster convergence times on average. The NEM algorithm injects noise into the data at each EM iteration. The noise decays with the iteration count to guarantee convergence to the optimal parameters of the original data model. The additive noise must also satisfy the NEM condition below that guarantees that the NEM parameter estimates will climb faster up the likelihood surface on average. The NEM Theorem [O. Osoba, S. Mitaim, and B. Kosko, “The noisy expectation-maximization algorithm,” Fluctuation and Noise Letters, Vol. 12, No. 3, p. 1350012, 2013] states a general sufficient condition when noise speeds up the EM algorithm's convergence to a local optimum. The NEM Theorem uses the following notation. The noise random variable N has pdf p(n|x). So the noise N can depend on the data x. h are the latent variables in the model. {θ⁽ⁿ⁾} is a sequence of EM estimates for θ. θ*=lim_{n→∞}θ⁽ⁿ⁾ is the converged EM estimate for θ. Define the noisy Q function

Q_{N}(θ|θ⁽ⁿ⁾)=E_{h|x,θ}_{^{k}} [ ln p(x+N,h|θ)].

### Theorem 2: Noisy Expectation Maximization (NEM)

The EM estimation iteration noise benefit

Q(θ*|θ*)−Q(θ⁽ⁿ⁾|θ*)≧Q(θ*|θ*)−Q_{N}(θ⁽ⁿ⁾|θ*) (4)

or equivalently

Q_{N}(θ₍ₙ₎|θ*)≧Q(θ₍ₙ₎|θ*) (5)

holds on average if the following positivity condition holds:

$${E}_{x , h , N \vert Θ *} [ ln ( \frac{p ( x + N , h \vert {Θ}_{k} )}{p ( x , h \vert {Θ}_{k} )} ) ] \geq 0 \qquad ( 6 )$$

The NEM Theorem states that each iteration of a suitably noisy EM algorithm gives higher likelihood estimates on average than do the regular EM's estimates. So the NEM algorithm converges faster than EM. The faster NEM convergence occurs both because the likelihood function has an upper bound and because the NEM algorithm takes larger average steps up the likelihood surface.

Maximum A Posteriori (MAP) estimation for missing information problems can use a modified version of the EM algorithm. The MAP version modifies the Q-function by adding a log prior term G(θ)=ln p(θ) [F. Seide, G. Li, and D. Yu, “Conversational speech transcription using context-dependent deep neural networks,” in Proc. Interspeech, 2011, pp. 437-440; G. Dahl, M. Ranzato, A. Mohamed, and G. Hinton, “Phone recognition with the mean-covariance restricted boltzmann machine,” Proc. NIPS, vol. 23, pp. 469-477, 2010]:

Q(θ|θₜ)=E_{h|x,θ}_{^{t}}[ ln p(x,h|θ)]+G(θ). (7)

The MAP version of the NEM algorithm applies a similar modification to the Q_{N}-function:

Q_{N}(θ|θₜ)=E_{h|x,θ}_{^{t}}[ ln p(x+N,h|θ)]+G(θ). (8)

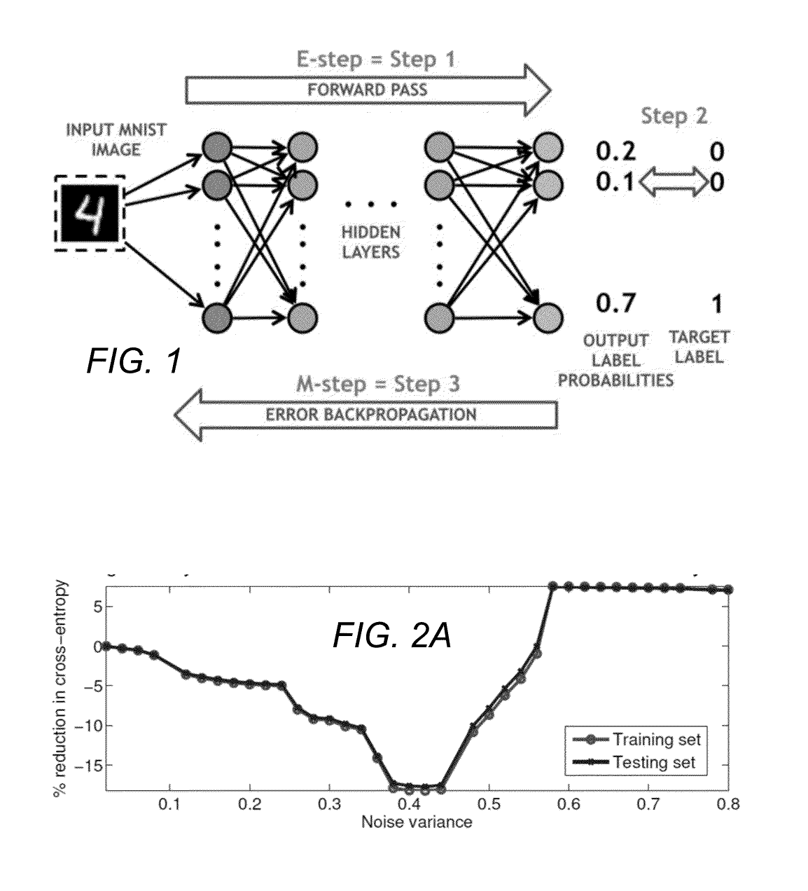

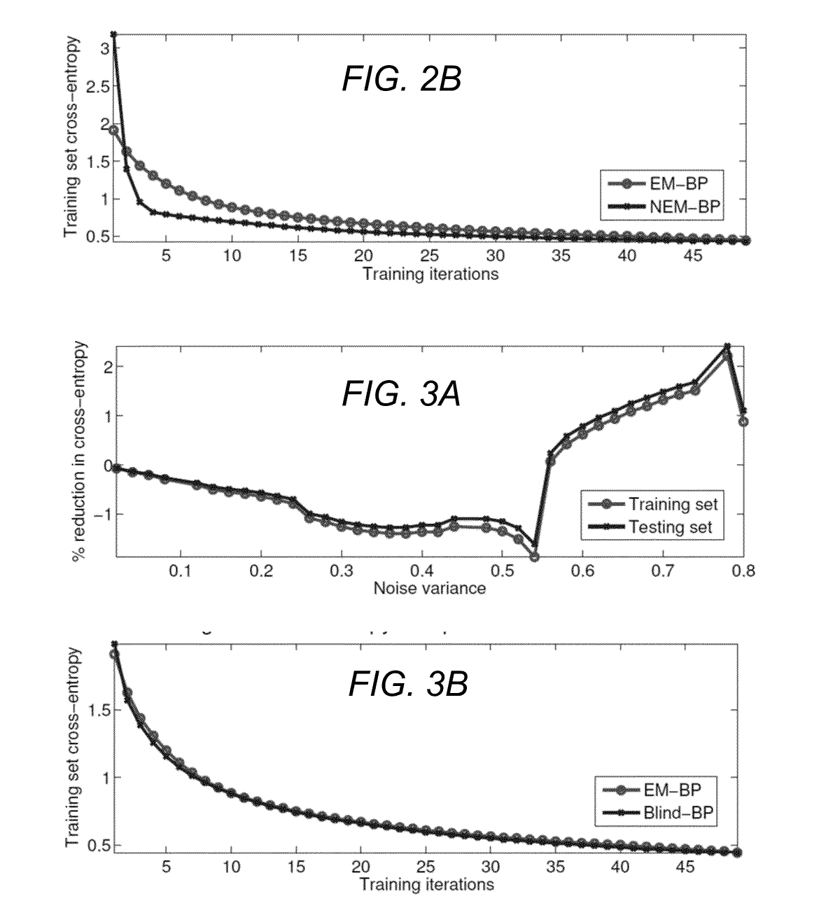

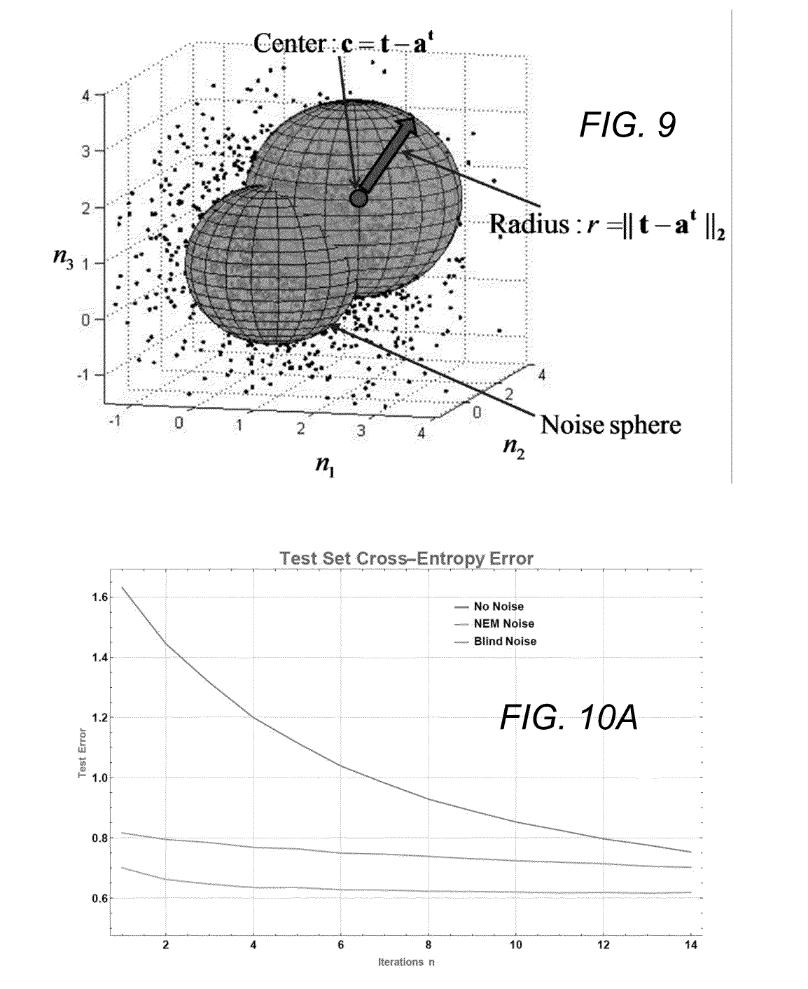

FIG. 1 illustrates this BP⇄EM equivalence for a feed-forward neural network with multiple hidden layers. FIGS. 8 and 9 show the geometry of the noise benefit sufficient condition for the special case of cross-entropy and squared-error BP. FIGS. 2A and 2B show the noise benefit for cross entropy training of a feedforward neural network. The NEM version displays a 18% median decrease in cross entropy per iteration compared to noiseless backpropagation training. FIGS. 3A and 3B show that adding blind noise instead of NEM noise only gives a miniscule improvement of 1.7% in cross entropy over the noiseless EM-BP algorithm.

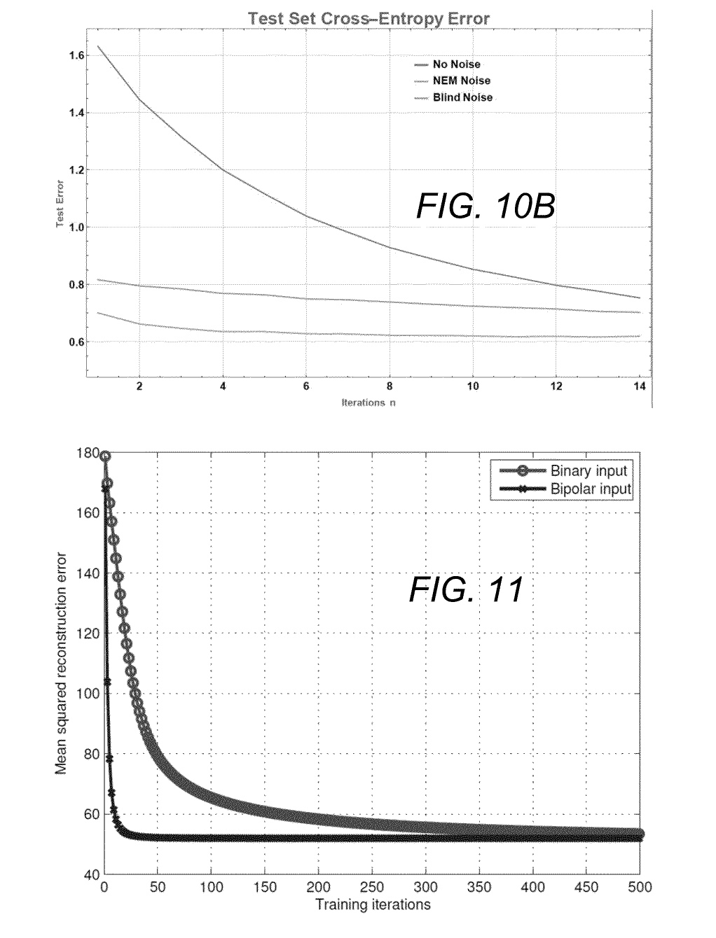

NEM-BP noise adds to both the output and hidden neurons of a neural network. Theorems 3 and 4 below prove the benefit of adding noise to the output neurons. The NEM noise benefit also applies to the hidden neurons as Theorem 5 below shows. FIGS. 8 and 9 illustrate the geometry of additive NEM noise for logistic and Gaussian output neurons. FIGS. 10A and 10 show the effects of NEM versus no noise injection in the hidden layers of a neural network. A 60.44% relative reduction in the per-iteration training set cross-entropy and a 54.39% relative reduction in the per-iterations testing set cross-entropy for NEM was observed, compared with standard back propagation.

### Theorem 3. Forbidden Hyperplane Noise Benefit Condition

The NEM positivity condition holds for ML training of feedforward neural network with Gibbs activation output neurons if

E_{t,h,n|x,θ*}_{ⁿ}n^{T} log(a^{t})^{o}≧0. (9)

Theorem 4. Forbidden Sphere Noise Benefit Condition The NEM positivity condition holds for ML training of a feedforward neural network with Gaussian output neurons if

[symbol]

_{t,h,n|,x,θ*}{∥n−a^{t}+t∥²−∥a^{t}−t∥²}≦0 (10)

where ∥.∥ is the L₂ vector norm.

### Theorem 5: Noise for Hidden Units

NEM noise n added to the output layer satisfies the NEM condition at the hidden layer if

(U^{T}n)^{T} log(a^{h})≧0 (11)

where U is the J×K weight matrix connecting the hidden and output layer and a^{h} is the vector of hidden layer activations.

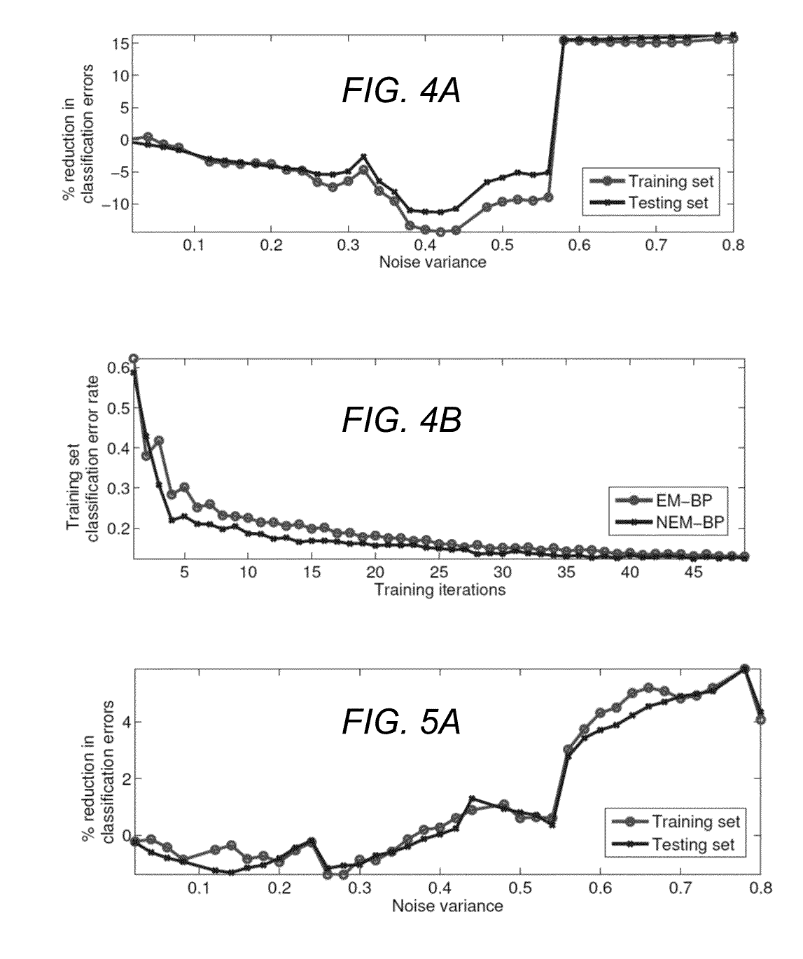

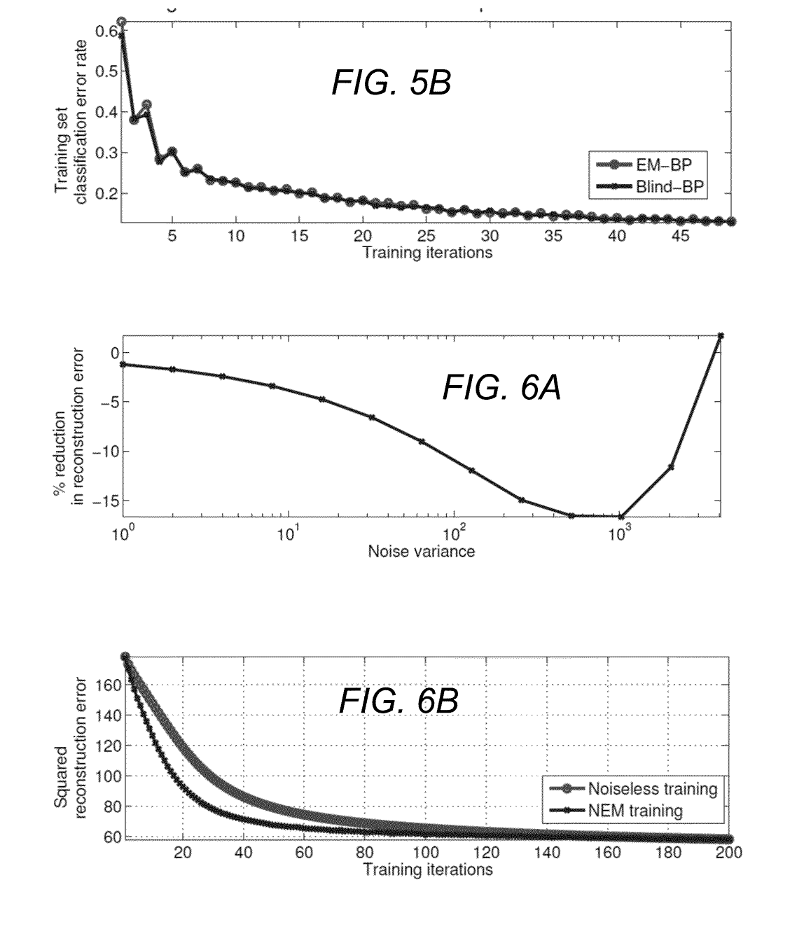

NEM-BP is shown to also give better classification accuracy at each training iteration than the noiseless EM-BP algorithm. This happens because NEM noise improves the cross entropy at every iteration and because cross entropy is an approximation to the classification error rate. FIGS. 4A and 4B show that NEM-BP gives a 15% median improvement in the per-iteration classification error rate for the training set and a 10% improvement for the testing set at the optimal noise variance of 0.42. FIGS. 5A and 5B show that this noise benefit disappears upon using blind noise in place of NEM noise.

A related NEM result is shown to hold for the pre-training of the individual layers of neurons in the multilayer perceptron. NEM-based theorems 3 and 4 also give the sufficient conditions for a noise benefit in the popular cases of neural networks with logistic and Gaussian output neurons. Theorems 6 and 7 give similar sufficient conditions for Bernoulli-Bernoulli and Gaussian-Bernoulli BAMs.

### Theorem 6: Forbidden Hyperplane Noise Benefit Condition

The NEM positivity condition holds for Bernoulli-Bernoulli RBM training if

[symbol]

_{x,h,n|θ*}{n^{T}(Wh+b)}≧0. (12)

### Theorem 7: Forbidden Sphere Noise Benefit Condition

The NEM positivity condition holds for Gaussian-Bernoulli RBM training if

$${E}_{x , h , n \vert Θ *} \{ \frac{1}{2} {‖ n ‖}^{2} - {n}^{T} ( Wh + b - x ) \} \leq 0. \qquad ( 13 )$$

This is a type of “stochastic resonance” effect where a small amount of noise improves the performance of a nonlinear system while too much noise harms the system [B. Kosko, Noise. Viking, 2006.; A. Patel and B. Kosko, “Levy Noise Benefits in Neural Signal Detection,” in Acoustics, Speech and Signal Processing, 2007. ICASSP 2007. IEEE International Conference on, vol. 3, 2007, pp. III-1413-III-1416.; M. McDonnell, N. Stocks, C. Pearce, and D. Abbott, Stochastic resonance: from suprathreshold stochastic resonance to stochastic signal quantization. Cambridge University Press, 2008; M. Wilde and B. Kosko, “Quantum forbidden-interval theorems for stochastic resonance,” Journal of Physical A: Mathematical Theory, vol. 42, no. 46, 2009.; A. Patel and B. Kosko, “Error-probability noise benefits in threshold neural signal detection,” Neural Networks, vol. 22, no. 5, pp. 697-706, 2009.; B. Franzke and B. Kosko, “Noise Can Speed Convergence in Markov Chains,” Physical Review E, vol. 84, no. 4, p. 041112, 2011.; A. Bulsara, R. Boss, and E. Jacobs, “Noise effects in an electronic model of a single neuron,” Biological cybernetics, vol. 61, no. 3, pp. 211-222, 1989]. Some prior research has found an approximate regularizing effect of adding white noise to backpropagation [C. M. Bishop, “Training with noise is equivalent to Tikhonov regularization,” Neural computation, vol. 7, no. 1, pp. 108-116, 1995.; Y. Hayakawa, A. Marumoto, and Y. Sawada, “Effects of the chaotic noise on the performance of a neural network model for optimization problems,” Physical review E, vol. 51, no. 4, pp. 2693-2696, 1995.; K. Matsuoka, “Noise injection into inputs in back-propagation learning,” Systems, Man and Cybernetics, IEEE Transactions on, vol. 22, no. 3, pp. 436-440, 1992.; G. An, “The effects of adding noise during backpropagation training on a generalization performance,” Neural Computation, vol. 8, no. 3, pp. 643-674, 1996]. The geometry of the main noise result shows that blindly picking noise from both above and below the NEM hyperplane should not on average produce a noise benefit.

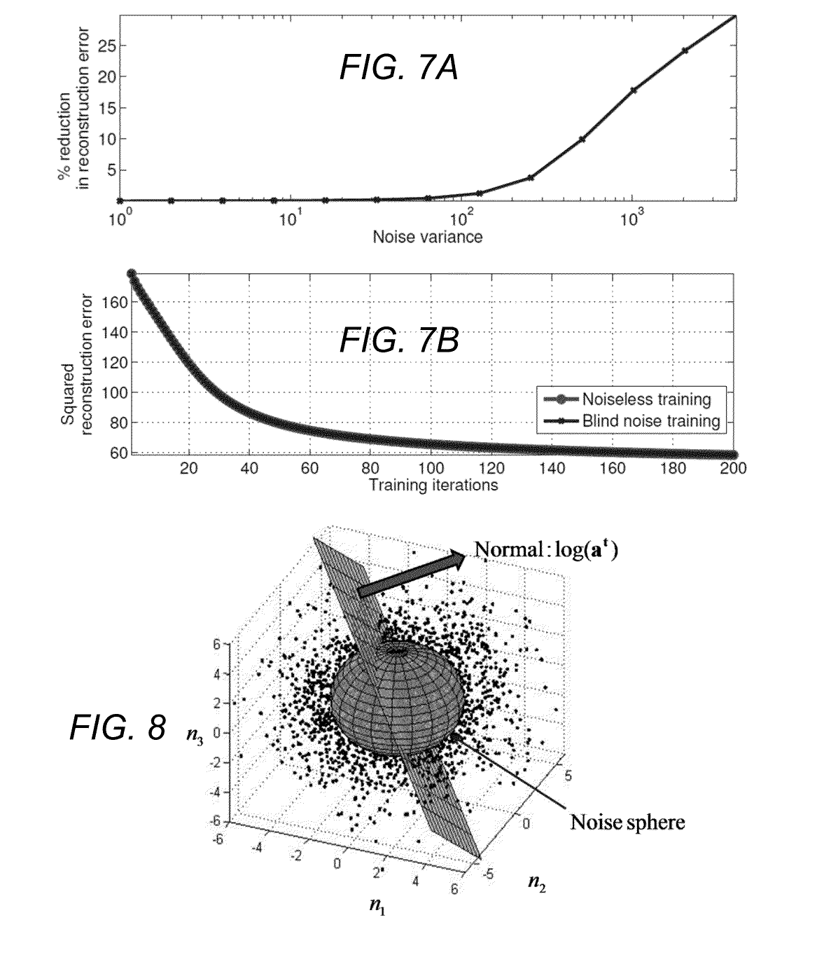

FIGS. 6A and 6B show the noise benefit for NEM training of a logistic-logistic BAM with 784 visible and 40 hidden neurons. NEM training gives around 16% improvement in the per-iteration squared reconstruction error over noiseless training. FIGS. 7A and 7B show that training with blind noise does not give any significant difference. The NEM Theorem gives a type of “forbidden” condition [A. P. Dempster, N. M. Laird, and D. B. Rubin, “Maximum likelihood from incomplete data via the EM algorithm,” Journal of the Royal Statistical Society. Series B (Methodological), pp. 1-38, 1977; G. J. McLachlan and T. Krishnan, The EM algorithm and extensions. Wiley-Interscience, 2007, vol. 382; Y. LeCun, Y. Bengio, and G. Hinton, “Deep learning,” Nature, vol. 521, pp. 436-444, 2015; B. Kosko, Noise. Viking, 2006; A. Patel and B. Kosko, “Levy Noise Benefits in Neural Signal Detection,” in Acoustics, Speech and Signal Processing, 2007. ICASSP 2007. IEEE International Conference on, vol. 3, 2007, pp. III-1413-III-1416] that ensures a noise speed up so long as the noise lies outside of a specified region in the noise state space. FIGS. 8 and 9 show that the noise must lie outside such regions to speed convergence. The neuron probability density function (pdf) and network connection or synaptic weights control the geometry of this forbidden region. Logistic neurons give the forbidden region as a half-space while Gaussian neurons give it as a sphere. FIG. 11 also shows that bipolar neuron coding tends to improve performance compared to binary coding.

The use of blind or unconditional noise to learning algorithms has a long history in neural networks and machine learning. Minsky observed in his 1961 overview of artificial intelligence that “one may use noise added to each variable” in state-space search based on random hill climbing [M. Minsky, “Steps toward artificial intelligence,” Proceedings of the IRE, vol. 49, no. 1, pp. 8-30, 1961]. Widrow showed in 1976 that adding blind noise to the gradient parameters of the LMS algorithm can improve convergence [B. Widrow and J. M. McCool, “A comparison of adaptive algorithms based on the methods of steepest descent and random search,” Antennas and Propagation, IEEE Transactions on, vol. 24, no. 5, pp. 615-637, 1976]. LMS applies to a minimal linear network with no hidden neurons. More recent work has found an approximate regularizing effect of adding blind white noise to BP [C. M. Bishop, “Training with noise is equivalent to Tikhonov regularization,” Neural computation, vol. 7, no. 1, pp. 108-116, 1995.; Y. Hayakawa, A. Marumoto, and Y. Sawada, “Effects of the chaotic noise on the performance of a neural network model for optimization problems,” Physical review E, vol. 51, no. 4, pp. 2693-2696, 1995.; K. Matsuoka, “Noise injection into inputs in back-propagation learning,” Systems, Man and Cybernetics, IEEE Transactions on, vol. 22, no. 3, pp. 436-440, 1992.; G. An, “The effects of adding noise during backpropagation training on a generalization performance,” Neural Computation, vol. 8, no. 3, pp. 643-674, 1996.].

The NEM approach described herein does not add blind noise to a network. It adds specially chosen noise to the data or the network neurons or related parameters. The use of blind white noise for regularization differs from injecting NEM noise. The geometry of the main noise result also shows that blindly picking noise from both above and below the NEM hyperplane should not on average produce a noise benefit. This holds because on average noise from above the NEM hyperplane improves convergence or accuracy while noise from below it only degrades performance on average.

The NEM noise-injection results also differ from “noise contrastive estimation” [M. U. Gutmann and A. Hyvarinen, “Noise-contrastive estimation of unnormalized statistical models, with applications to natural image statistics,” The Journal of Machine Learning Research, vol. 13, no. 1, pp. 307-361, 2012; A. Mnih and K. Kavukcuoglu, “Learning word embeddings efficiently with noise-contrastive estimation,” in Proc. Advances in Neural Information Processing Systems, 2013, pp. 2265-2273] that uses a type of Monte Carlo randomization to simplify the computation of a normalization or partition function in logistic regression. This process does not inject noise into data. Nor does it work with BP-based deep learning on multi-neuron networks. It instead compares training with data to training from blind noise. So the NEM noise boost could in principle apply to its data training. Noise contrastive estimation also randomly picks subsets of data for processing. The BAM convergence theorem does allow random selection of neurons for updating as discussed below. But that does not involve the NEM noise-injection process. Conclusion

The backpropagation algorithm is a special case of the generalized EM algorithm. So proper noise injection speeds backpropagation convergence because it speeds EM convergence. These sufficient conditions use the recent noisy EM (NEM) theorem. Similar sufficient conditions hold for a noise benefit in pre-training neural networks based on the NEM theorem. Noise-injection simulations on the MNIST digit recognition data set reduced both the network cross entropy and classification error rate.

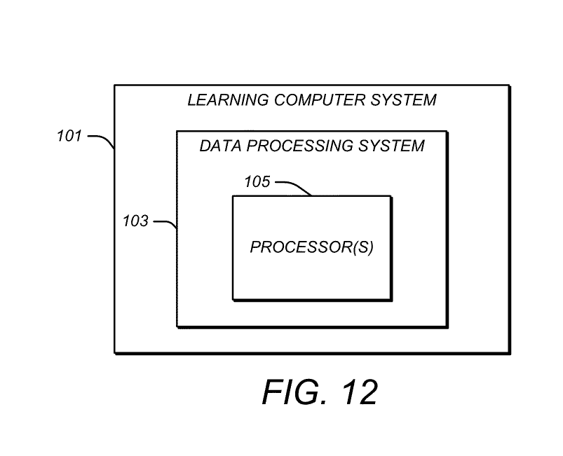

FIG. 12 illustrates an example of a learning computer system 101 that estimates unknown parameters and states of a stochastic or uncertain system. The learning computer system is configured to implement the various approaches that have been discussed herein. The learning computer system may include a data processing system 103, which may include one or more hardware processors 105. The learning computer system may also include one or more tangible memories (e.g., random access memories (RAMs), read-only memories (ROMs), and/or programmable read only memories (PROMS)), tangible storage devices (e.g., hard disk drives, CD/DVD drives, and/or flash memories), system buses, video processing components, network communication components, input/output ports, and/or user interface devices (e.g., keyboards, pointing devices, displays, microphones, sound reproduction systems, and/or touch screens).

The learning computer system may include one or more computers at the same or different locations. When at different locations, the computers may be configured to communicate with one another through a wired and/or wireless network communication system.

The learning computer system may include software (e.g., one or more operating systems, device drivers, application programs, and/or communication programs). When software is included, the software includes programming instructions and may include associated data and libraries. When included, the programming instructions are configured to implement one or more algorithms that implement one or more of the functions of the computer system, as recited herein. The description of each function that is performed by each computer system also constitutes a description of the algorithm(s) that performs that function.

The software may be stored on or in one or more non-transitory, tangible storage devices, such as one or more hard disk drives, CDs, DVDs, and/or flash memories. The software may be in source code and/or object code format. Associated data may be stored in any type of volatile and/or non-volatile memory. The software may be loaded into a non-transitory memory and executed by one or more processors.

The components, steps, features, objects, benefits, and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits, and/or advantages. These also include embodiments in which the components and/or steps are arranged and/or ordered differently.

For example, For example, the injected perturbations can be based on noise, or chaos, or fuzz, or uncertain random variables. The injection itself need not be additive. It can also be multiplicative or have any functional form. The perturbations that boost the random sampling of training samples can exploit bootstrapping and general forms of Monte Carlo sampling.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases from a claim means that the claim is not intended to and should not be interpreted to be limited to these corresponding structures, materials, or acts, or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element preceded by an “a” or an “an” does not, without further constraints, preclude the existence of additional elements of the identical type.

None of the claims are intended to embrace subject matter that fails to satisfy the requirement of Sections 101, 102, or 103 of the Patent Act, nor should they be interpreted in such a way. Any unintended coverage of such subject matter is hereby disclaimed. Except as just stated in this paragraph, nothing that has been stated or illustrated is intended or should be interpreted to cause a dedication of any component, step, feature, object, benefit, advantage, or equivalent to the public, regardless of whether it is or is not recited in the claims.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

The invention claimed is:

1. A learning computer system that updates parameters and states of an uncertain system comprising a data processing system that includes a hardware processor that has a configuration that:
receives data from a user or other source;
processes the received data through layers of processing units, thereby generating processed data;
processes the processed data to produce one or more intermediate or output signals;
compares the one or more intermediate or output signals with one or more reference signals to generate information indicative of a performance measure of one or more of the layers of processing units;
sends information indicative of the performance measure back through the layers of processing units;
processes the information indicative of the performance measure in the processing units and in interconnections between the processing units;
generates random, chaotic, fuzzy, or other numerical perturbations of the received data, the processed data, or the one or more intermediate or output signals;
updates the parameters and states of the uncertain system using the received data, the numerical perturbations, and previous parameters and states of the uncertain system;
determines whether the generated numerical perturbations satisfy a condition; and
if the numerical perturbations satisfy the condition, injects the numerical perturbations into one or more of the parameters or states, the received data, the processed data, or one or more of the processing units.

2. The learning computer system of claim 1 wherein the learning computer system unconditionally injects noise or chaotic or other perturbations into one or more of the estimated parameters or states, the received data, the processed data, or one or more of the processing units.

3. The learning computer system of claim 2 wherein the unconditional injection speeds up learning by the learning computer system.

4. The learning computer system of claim 2 wherein the unconditional injection improves the accuracy of the learning computer system.

5. The learning computer system of claim 1 wherein, if the numerical perturbations do not satisfy the condition, the system does not inject the numerical perturbations into one or more of the parameters or states, the received data, the processed data, or one or more of the processing units.

6. The learning computer system of claim 1 wherein the received data represents an image, a speech signal, or other signal.

7. The learning computer system of claim 1 wherein the injection speeds up learning by the learning computer system.

8. The learning computer system of claim 1 wherein the injection improves the accuracy of the learning computer system.

9. A learning computer system that updates parameters and states of an uncertain system comprising a data processing system that includes a hardware processor that has a configuration that:
receives data from a user or other source;
processes the received data bi-directionally through two layers of processing units, thereby generating processed data;
generates random, chaotic, fuzzy, or other numerical perturbations of the received data, the processed data, or one or more signals within the two layers of processing units;
updates the parameters and states of the uncertain system using the received data, the numerical perturbations, and previous parameters and states of the uncertain system;
determines whether the generated numerical perturbations satisfy a condition; and
if the numerical perturbations satisfy the condition, injects the numerical perturbations into one or more of the parameters or states, the received data, the processed data, or one or more of the processing units.

10. The learning computer system of claim 9 wherein the learning computer system repeats all of the steps of claim 9, except that the processing step during the repeat processes one or both of the two layers of processing units along with a third layer of a processing unit.

11. The learning computer system of claim of claim 10 wherein the learning computer system repeats all of the steps of claim 10 until the received data has been processed bi-directionally through all of the layers of the processing units.

12. The learning computer system of claim of claim 9 wherein the processing units in the two layers of processing units process bi-polar signals.

13. The learning computer system of claim 9 wherein the learning computer system unconditionally injects noise or chaotic or other perturbations into one or more of the estimated parameters or states, the received data, the processed data, or the processing units.

14. A non-transitory, tangible, computer-readable storage medium containing a program of instructions that causes a learning computer system running the program of instructions that has a data processing system that includes a hardware processor to update parameters and states of an uncertain system by:
receiving data from a user or other source;
processing the received data through layers of processing units, thereby generating processed data;
processing the processed data to produce one or more intermediate or output signals;
comparing the one or more intermediate or output signals with one or more reference signals to generate information indicative of a performance measure of one or more of the layers of processing units;
sending information indicative of the performance measure back through the layers of processing units;
processing the information indicative of the performance measure in the processing units and in interconnections between the processing units;
generating random, chaotic, fuzzy, or other numerical perturbations of the received data, the processed data, or the one or more intermediate or output signals;
updating the parameters and states of the uncertain system using the received data, the numerical perturbations, and previous parameters and states of the uncertain system;
determining whether the generated numerical perturbations satisfy a condition; and
if the numerical perturbations satisfy the condition, injecting the numerical perturbations into one or more of the parameters or states, the received data, the processed data, or one or more of the processing units.

15. The storage medium of claim 14 wherein the program of instructions causes the learning computer system to unconditionally inject noise or chaotic or other perturbations into one or more of the estimated parameters or states, the received data, the processed data, or the one or more processing units.

16. The storage medium of claim 15 wherein the unconditional injection speeds up learning by the learning computer system.

17. The storage medium of claim 15 wherein the unconditional injection improves the accuracy of the learning computer system.

18. The storage medium of claim 14 wherein, if the numerical perturbations do not satisfy the condition, the program of instructions causes the learning computer system not to inject the numerical perturbations into one or more of the parameters or states, the received data, the processed data, or one or more of the processing units.

19. The storage medium of claim 14 wherein the received data represents an image, a speech signal, or other signal.

20. The storage medium of claim 14 wherein the injection speeds up learning by the learning computer system.

21. The storage medium of claim 14 wherein the injection improves the accuracy of the learning computer system.

22. A non-transitory, tangible, computer-readable storage medium containing a program of instructions that causes a learning computer system running the program of instructions that has a data processing system that includes a hardware processor to update parameters and states of an uncertain system by:
receiving data from a user or other source;
processing the received data bi-directionally through two layers of processing units, thereby generating processed data;
generating random, chaotic, fuzzy, or other numerical perturbations of the received data, the processed data, or one or more signals within the two layers of processing units;
updating the parameters and states of the uncertain system using the received data, the numerical perturbations, and previous parameters and states of the uncertain system;
determining whether the generated numerical perturbations satisfy a condition; and
if the numerical perturbations satisfy the condition, injecting the numerical perturbations into one or more of the parameters or states, the received data, the processed data, or one or more of the processing units.

23. The storage medium of claim 22 wherein the program of instructions causes the learning computer system to repeat all of the steps of claim 22, except that the processing step during the repeat processes one or both of the two layers of processing units along with a third layer of a processing unit.

24. The storage medium of claim of claim 23 wherein the program of instructions causes the learning computer system to repeat all of the steps of claim 23 until the received data has been processed bi-directionally through all of the layers of the processing units.

25. The storage medium of claim of claim 22 wherein processing units in the two layers of processing units process bi-polar signals.

26. The storage medium of claim 22 wherein the program of instructions causes the learning computer system to unconditionally inject noise or chaotic or other perturbations into one or more of the estimated parameters or states, the received data, the processed data, or the processing units.
